(19) United States
(12) Patent Application Publication
(10) Pub. No.: US 2026/0230824 A1
(43) Pub. Date: Aug. 6, 2026

(54) SERVER AND METHOD FOR FACILITATING DETECTING MANIPULATION OF LOCATION DATA

(71) Applicant: Grabtaxi Holdings Pte. Ltd., Singapore (SG)

(72) Inventors: Qi HUANG, Bellevue, WA (US); Laiyi LIN, Singapore (SG); Ze CHEN, Bellevue, WA (US); Haitao BAO, Singapore (SG)

(21) Appl. No.: 19/044,709

(22) Filed: Feb. 4, 2025

(51) Int. Cl. H04W 12/104

(52) U.S. Cl. CPC H04W 12/104

(57) ABSTRACT

According to various embodiments, there is a server for facilitating detecting a manipulation of location data, the server comprising: a memory configured to store instructions; and a processor for executing the stored instructions and configured to: obtain the location data from a computing device associated with a user; obtain one or more sensing data detected by one or more sensors of the computing device from the computing device; input the one or more sensing data and the location data into a machine learning model, wherein the machine learning model is configured to aggregate the one or more sensing data and the location data, and output a score based on a model probability for the manipulation; and determine a probability that the location data is manipulated based on the score.

### TECHNICAL FIELD

Various embodiments relate to a server and a method for facilitating detecting a manipulation of location data.

### BACKGROUND

GPS spoofing has emerged as a significant challenge for companies reliant on accurate GPS data to power their products (for example, gaming companies and on-demand service platforms). Numerous GPS spoofing applications that allow users to alter their GPS locations with ease are readily available. Basic GPS spoofing applications may allow users to emulate any location on a map, while advanced GPS spoofing applications may allow the users to simulate movement along predefined routes, or provide an on-demand movement using a joystick (for example, Mock Locations). The GPS spoofing applications may include features to adjust the speed of simulated movement.

In the context of augmented reality games, GPS spoofing may undermine a gaming experience by giving unfair advantages to players who spoof their locations. In the on-demand service platforms (for example, ride-hailing platforms), drivers may exploit GPS spoofing to manipulate booking allocation algorithms, simulate fake rides, and abuse incentive schemes. These may impact trustworthiness of the ride-hailing platforms for both drivers and consumers, and more importantly, result in a monetary loss arising from the incentive abuse.

Conventional solutions for detecting the GPS spoofing may mainly focus on identifying suspicious GPS traces, such as sudden jumps in GPS data (for example, latitude, longitude, or altitude) and long periods of stale GPS pings. These solutions may provide clear signals when the GPS traces are highly anomalous (for example, jumps are sufficiently large), but may be less reliable in borderline cases (for example, detecting spoofing to nearby locations). Furthermore, GPS data quality issues arising from multipath problems in build-up areas or sensor degradation in old computing devices may lead to false positives.

With access to computing device data, additional solutions for detecting the GPS spoofing may include identifying signs of device tampering (for example, rooted phones or enabled developer options), flagging discrepancies in IP addresses or cell towers, and blocking known GPS spoofing applications. However, these solutions may provide only indirect evidence of the GPS spoofing and lack the confidence required for definitive detection.

Moreover, GPS spoofing techniques may continuously evolve, often in response to existing detecting methods. For example, if detecting algorithms target abrupt GPS jumps, spoofing tools may adapt by simulating smaller, more gradual movements. The frequent emergence of new GPS spoofing applications may further complicate efforts to maintain comprehensive detecting solutions or curate exhaustive lists of the GPS spoofing applications for effective blocking.

Therefore, there is a need to provide a server and a method for facilitating detecting a manipulation of location data to address the above problems.

### SUMMARY

According to various embodiments, there is a server for facilitating detecting a manipulation of location data, the server comprising: a memory configured to store instructions; and a processor for executing the stored instructions and configured to: obtain the location data from a computing device associated with a user; obtain one or more sensing data detected by one or more sensors of the computing device from the computing device; input the one or more sensing data and the location data into a machine learning model, wherein the machine learning model is configured to aggregate the one or more sensing data and the location data, and output a score based on a model probability for the manipulation; and determine a probability that the location data is manipulated based on the score.

In some embodiments, the processor is further configured to: compare the score and a predetermined threshold; and determine whether the location data is manipulated based on the comparison between the score and the predetermined threshold, wherein if the score is equal to or greater than the predetermined threshold, the processor is configured to determine that the location data is manipulated; and if the score is less than the predetermined threshold, the processor is configured to determine that the location data is not manipulated.

In some embodiments, the processor is further configured to: if it is determined that the location data is manipulated, trigger the user to perform a predetermined task to allow the user to provide an on-demand service relating to the location data.

In some embodiments, the processor is further configured to: set a plurality of predetermined thresholds each corresponding to a plurality of scenarios for the on-demand service, based on a critical level of each of the plurality of scenarios; determine one of the plurality of scenarios based on characteristics of an order for the on-demand service; and compare the score and one of the plurality of predetermined thresholds corresponding to the determined scenario, to determine whether the location data is manipulated.

In some embodiments, the one or more sensing data include at least one of raw GPS (Global Positioning System) measurements data, accelerometer data, and raw GNSS (Global Navigation Satellite System) measurements data.

In some embodiments, the raw GPS measurements data includes GPS longitude data and GPS latitude data of the computing device, and the machine learning model is further configured to compute a relative distance of the GPS longitude data and the GPS latitude data to a pick-up location and a drop-off location, and compute a distribution of the location data, to obtain the score based on the relative distance and the distribution.

In some embodiments, the raw GPS measurements data includes GPS speed data and GPS accuracy data of the computing device, and the machine learning model is further configured to exclude at least one GPS ping which is less than a predetermined quality value, based on the GPS accuracy data, and compute a variance of the GPS speed data, to obtain the score based on at least one remaining GPS ping and the variance.

In some embodiments, the accelerometer data includes 3-axis accelerometer data of the computing device, and the machine learning model is further configured to obtain a vibrational pattern of the computing device in a frequency domain by inputting the 3-axis accelerometer data into an FFT (Fast Fourier Transform) algorithm, and determine whether the computing device is in a vehicle based on the vibrational pattern, to obtain the score based on whether the computing device is in the vehicle.

In some embodiments, the machine learning model is further configured to perform a calculation using the raw GNSS measurements data to obtain GNSS latitude data and GNSS longitude data of the computing device; and compare the GNSS latitude data and the GNSS longitude data with the location data, to obtain the score based on the comparison between the GNSS latitude data and the GNSS longitude data and the location data.

In some embodiments, the one or more sensing data further include user specific data, and the user specific data includes at least one of information about whether a predetermined application is installed in the computing device, and information about whether a location of a cell tower is mapped to the location data.

According to various embodiments, there is a method for facilitating detecting a manipulation of location data, the method comprising: obtaining the location data from a computing device associated with a user; obtaining one or more sensing data detected by one or more sensors of the computing device from the computing device; inputting the one or more sensing data and the location data into a machine learning model, wherein the machine learning model is configured to aggregate the one or more sensing data and the location data, and output a score based on a model probability for the manipulation; and determining a probability that the location data is manipulated based on the score.

In some embodiments, the determining the probability that the location data is manipulated based on the score comprising: comparing the score and a predetermined threshold; and determining whether the location data is manipulated based on the comparison between the score and the predetermined threshold, wherein the determining whether the location data is manipulated based on the comparison between the score and the predetermined threshold comprising: if the score is equal to or greater than the predetermined threshold, determining that the location data is manipulated; and if the score is less than the predetermined threshold, determining that the location data is not manipulated.

In some embodiments, the method further comprises: if it is determined that the location data is manipulated, triggering the user to perform a predetermined task to allow the user to provide an on-demand service relating to the location data.

In some embodiments, the determining the probability that the location data is manipulated based on the score comprising: setting a plurality of predetermined thresholds each corresponding to a plurality of scenarios for the on-demand service, based on a critical level of each of the plurality of scenarios; determining one of the plurality of scenarios based on characteristics of an order for the on-demand service; and comparing the score and one of the plurality of predetermined thresholds corresponding to the determined scenario, to determine whether the location data is manipulated.

In some embodiments, the one or more sensing data include at least one of raw GPS (Global Positioning System) measurements data, accelerometer data, and raw GNSS (Global Navigation Satellite System) measurements data.

In some embodiments, the raw GPS measurements data includes GPS longitude data and GPS latitude data of the computing device, and the machine learning model is further configured to compute a relative distance of the GPS longitude data and the GPS latitude data to a pick-up location and a drop-off location, and compute a distribution of the location data, to obtain the score based on the relative distance and the distribution.

In some embodiments, the raw GPS measurements data includes GPS speed data and GPS accuracy data of the computing device, and the machine learning model is further configured to exclude at least one GPS ping which is less than a predetermined quality value, based on the GPS accuracy data, and compute a variance of the GPS speed data, to obtain the score based on at least one remaining GPS ping and the variance.

In some embodiments, the accelerometer data includes 3-axis accelerometer data of the computing device, and the machine learning model is further configured to obtain a vibrational pattern of the computing device in a frequency domain by inputting the 3-axis accelerometer data into an FFT (Fast Fourier Transform) algorithm, and determine whether the computing device is in a vehicle based on the vibrational pattern, to obtain the score based on whether the computing device is in the vehicle.

In some embodiments, the machine learning model is further configured to perform a calculation using the raw GNSS measurements data to obtain GNSS latitude data and GNSS longitude data of the computing device; and compare the GNSS latitude data and the GNSS longitude data with the location data, to obtain the score based on the comparison between the GNSS latitude data and the GNSS longitude data and the location data.

In some embodiments, the one or more sensing data further include user specific data, and the user specific data includes at least one of information about whether a predetermined application is installed in the computing device, and information about whether a location of a cell tower is mapped to the location data.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

The invention will be better understood with reference to the detailed description when considered in conjunction with the non-limiting examples and the accompanying drawings, in which:

FIG. 1 illustrates an infrastructure of a system for facilitating detecting a manipulation of location data according to various embodiments.

FIG. 2 illustrates a block diagram of a server for facilitating detecting a manipulation of location data according to various embodiments.

FIG. 3 illustrates a flow diagram for a method for facilitating detecting a manipulation of location data according to various embodiments.

FIG. 4 illustrates a data flow diagram for a system for facilitating detecting a manipulation of location data according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other of the server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

Throughout the description, the term “module” may be understood as an application specific integrated circuit (ASIC), an electronic circuit, a combinational logic circuit, a field programmable gate array (FPGA), a processor which executes code, other suitable hardware components which provide the described functionality, or any combination thereof. The term of “module” may include a memory which stores code executed by the processor.

In the following, embodiments will be described in detail.

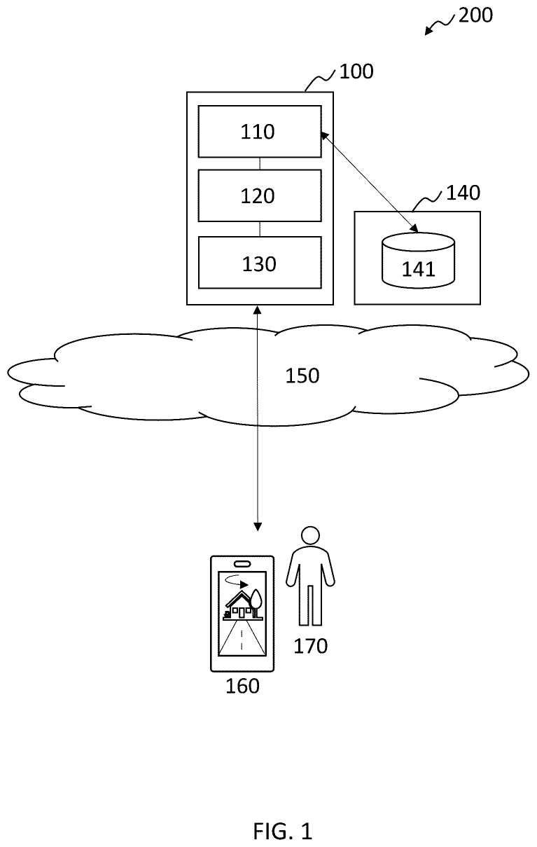

FIG. 1 illustrates an infrastructure of a system 200 for facilitating detecting a manipulation of location data according to various embodiments.

As shown in FIG. 1, the system 200 may include, but is not limited to, a server 100, a database system 140, and a network 150.

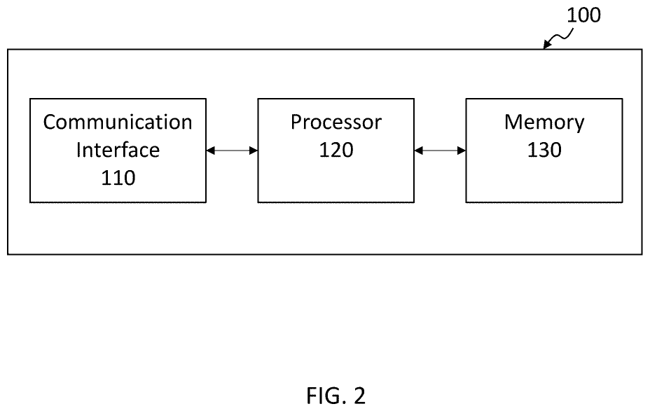

In some embodiments, the server 100, for example, implemented by a server computer, may include a communication interface 110, a processor 120, and a memory 130 (as will be described with reference to FIG. 2).

In some embodiments, the system 200 may further include a database 141. In some embodiments, the database 141 may be a part of the database system 140 which may be external to the server 100. The server 100 may communicate with the database 141. In some other embodiments, although not shown, the database 141 may be implemented locally in the memory 130 of the server 100.

In some embodiments, the system 200 may further include one or more computing devices 160 each associated with one or more users 170.

In some embodiments, the user 170 may include a consumer (who in some contexts herein may also be referred to as a “requester” or a “Pax”) for an on-demand service. In some embodiments, the user 170 may include a driver (who in some contexts herein may also be referred to as a “delivery service provider”, a “delivery partner”, a “delivery agent” or a “Dax”) for the on-demand service. In some embodiments, the user 170 may include a merchant (who in some contexts herein may also be referred to as a “retailer”, a “restaurant” or a “Mex”) for the on-demand service. In some embodiments, the user 170 may include a mapper and/or a general consumer, for example, a player of a game using location data.

In some embodiments, the on-demand service may be a service allowing the consumer to fulfil the consumer's demand via an immediate access to items and/or services. The consumer may request the on-demand service, such as a transport service or an item delivery service, using a user interface presented on the computing device associated with the consumer. The consumer may make an order for the on-demand service.

In some embodiments, the user 170 may use an application (also referred to as an “App”), for example, a mobile application, provided by the server 100. For example, the server 100 may be controlled and/or managed by an on-demand service platform provider. The application may be installed in the computing device 160 associated with the user 170, to interact with the server 100.

In some embodiments, the network 150 may include, but is not limited to, a Local Area Network (LAN), a Wide Area Network (WAN), a Global Area Network (GAN), or any combination thereof. The network 150 may provide a wireline communication, a wireless communication, or a combination of the wireline and wireless communication between the server 100 and the computing device 160. In some embodiments, the network 150 may provide the wireline communication, the wireless communication, or the combination of the wireline and wireless communication between a plurality of computing devices 160.

In some embodiments, the computing device 160 may be connectable to the server 100 via the network 150. In some embodiments, the computing device 160 may be arranged in data or signal communication with the server 100 via the network 150. In some embodiments, the computing device 160 may include, but is not limited to, at least one of the following: a mobile phone, a tablet computer, a laptop computer, a desktop computer, a head-mounted display, a smart watch, and a camera device. In some embodiments, the computing device 160 may be associated with the user 170. For example, the computing device 160 may belong to the user 170.

In some embodiments, the computing device 160 may include a location sensor. In some embodiments, the location sensor may communicate with at least one of a global positioning satellite (GPS) server, a network server, and a Wi-Fi server, to detect a location of the computing device 160. In some embodiments, the computing device 160 may generate information about the location (also referred to as “location data”) of the computing device 160. In some embodiments, the computing device 160 may include an accelerometer sensor. In some embodiments, the accelerometer sensor may obtain accelerometer data from the computing device 160. In some other embodiments, the computing device 160 may generate information about the location and an orientation of the computing device 160. In some embodiments, the computing device 160 may record the location and the orientation of the computing device 160 with every exposure. In some other embodiments, the computing device 160 may generate information about the location, the orientation of the computing device 160, and a speed of a movement of the computing device 160. In some embodiments, the computing device 160 may record the location, the orientation, and the speed of the movement of the computing device 160 with every exposure.

In some embodiments, the computing device 160 may send the information about the location of the computing device 160 to the server 100 via the network 150. The location of the computing device 160 may be considered as a location of the user 170. For example, if the user 170 is the driver, a trace of the location of the driver may be considered as a travel route of the driver to provide the on-demand service to the consumer. The server 100 may receive the trace of the location of the driver from the computing device 160, and recognise whether the driver has completed the provision of the on-demand service based on the trace of the location of the driver.

FIG. 2 illustrates a block diagram of a server 100 for facilitating detecting a manipulation of location data according to various embodiments.

As shown in FIG. 2, the server 100, for example, implemented by a server computer, may include a communication interface 110, a processor 120, and a memory 130.

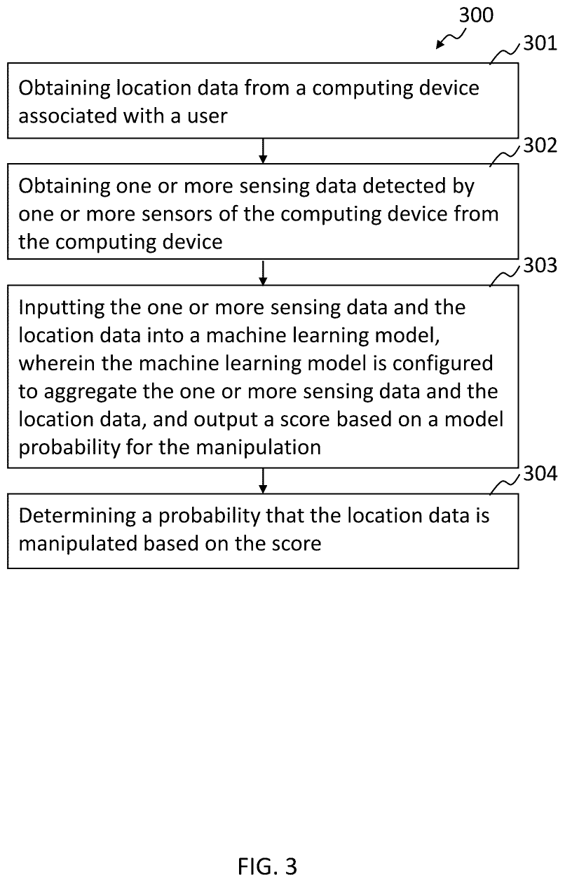

In some embodiments, the memory 130 (also referred to as a “database”) may store input data and/or output data temporarily or permanently. In some embodiments, the memory 130 may be configured to store instructions. In some embodiments, the memory 130 may store program code which allows the server 100 to perform a method 300 (as will be described with reference to FIG. 3). In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the communication interface 110 may allow one or more computing devices 160 to communicate with the processor 120 of the server 100 via a network 150, as shown in FIG. 1.

In some embodiments, the processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may be connectable to the communication interface 110. In some embodiments, the processor 120 may be arranged in data or signal communication with the communication interface 110 to transmit/receive the signals.

In some embodiments, the processor 120 may obtain the location data from the computing device 160 associated with the user 170. In some embodiments, the processor 120 may receive the location data from the computing device 160 via the communication interface 110. In some embodiments, the computing device 160 may include a location sensor. In some embodiments, the location sensor may communicate with at least one of a global positioning satellite (GPS) server, a network server, and a Wi-Fi server, to detect a location of the computing device 160. In some embodiments, the computing device 160 may generate information about the location (also referred to as “location data”) of the computing device 160. In some embodiments, the computing device 160 may send the information about the location of the computing device 160 to the communication interface 110 via the network 150. The location of the computing device 160 may be considered as a location of the user 170. For example, if the user 170 is the driver, a trace of the location of the driver may be considered as a travel route of the driver to provide the on-demand service to the consumer. The processor 120 may receive the trace of the location of the driver from the computing device 160 via the communication interface 110, and recognise whether the driver has completed the provision of the on-demand service based on the trace of the location of the driver.

In some embodiments, the processor 120 may obtain one or more sensing data detected by one or more sensors of the computing device 160 from the computing device 160. In some embodiments, the one or more sensing data may include, but are not limited to, at least one of raw GPS (Global Positioning System) measurements data, accelerometer data, and raw GNSS (Global Navigation Satellite System) measurements data. In some embodiments, the raw GPS measurements data may include GPS longitude data and GPS latitude data of the computing device 160. In some embodiments, the raw GPS measurements data may include GPS speed data and GPS accuracy data of the computing device 160. In some embodiments, the accelerometer data may include 3-axis accelerometer data of the computing device 160. In some embodiments, the raw GNSS measurements data may include GNSS latitude data and GNSS longitude data of the computing device 160.

In some embodiments, the processor 120 may input the one or more sensing data and the location data into a machine learning model. In some embodiments, the machine learning model may aggregate the one or more sensing data and the location data, and output a score based on a model probability for the manipulation.

In some embodiments, where the one or more sensing data includes the raw GPS measurements data including the GPS longitude data and the GPS latitude data of the computing device 160, the machine learning model may compute a relative distance of the GPS longitude data and the GPS latitude data to a pick-up location and a drop-off location of the on-demand service, and compute a distribution of the location data. The machine learning model may obtain the score based on the relative distance and the distribution.

In some embodiments, where the one or more sensing data includes the raw GPS measurements data including the GPS speed data and the GPS accuracy data of the computing device 160, the machine learning model may exclude at least one GPS ping which is less than a predetermined quality value, based on the GPS accuracy data, and compute a variance of the GPS speed data. The machine learning model may obtain the score based on at least one remaining GPS ping and the variance.

In some embodiments, as the objective for most GPS spoofing may be to alter the location data, the raw GPS speed data may provide a quick assessment of a possible usage of FGPS (false GPS). In the absence of sophisticated spoofing simulations where the GPS speed is also spoofed to change along the route of travel, the variance of the GPS speed is likely to be close to 0. This may be the first sign of the possible GPS spoofing.

In some embodiments, where the one or more sensing data includes the accelerometer data including the 3-axis accelerometer data of the computing device 160, the machine learning model may obtain a vibrational pattern of the computing device 160 in a frequency domain by inputting the 3-axis accelerometer data into an FFT (Fast Fourier Transform) algorithm, and determine whether the computing device 160 is in a vehicle based on the vibrational pattern. The machine learning model may obtain the score based on whether the computing device 160 is in the vehicle.

In some embodiments, the computing device 160 may include an accelerometer sensor (for example, an in-built accelerometer sensor) where acceleration measurements of the computing device 160 may be easily obtained. The FFT (Fast Fourier Transform) of raw accelerometer data (also referred to as “accelerometer sensor data”) may reveal a frequency composition of the signal which is able to give an indication of possible vibrational movements of the computing device 160. For example, a high proportion of high frequency components may be due to the vibrational movements when the computing device 160 is in the vehicle. On the on-demand service platform (for example, a ride-hailing platform), an actual ride on the vehicle (for example, a car or a motorcycle) may subject the computing device 160 to vehicular vibrations which may show up as signals in the transformed accelerometer data. If such vehicular vibrational motions are absent, it may show a possibility of spoofing in a stationary spot. Such signals may become clearer if the accelerometer data is collected at a high collection frequency.

In some embodiments, where the one or more sensing data includes the raw GNSS measurements data, the machine learning model may perform a calculation using the raw GNSS measurements data to obtain GNSS latitude data and GNSS longitude data of the computing device 160. The machine learning model may compare the GNSS latitude data and the GNSS longitude data with the location data. The machine learning model may obtain the score based on the comparison between the GNSS latitude data and the GNSS longitude data and the location data.

In some embodiments, the raw GNSS measurements (also referred to as “GNSS satellite measurements”) may be collected and processed to obtain readable the GNSS latitude data and the GNSS longitude data. These values (i.e. the GNSS latitude data and the GNSS longitude data) may be derived from the raw GNSS measurements via a triangulation algorithm based on a position of a plurality of satellites. The GNSS locations may be then compared with values directly read from a GPS sensor by third-party applications (for example, a GPS-based game application or a ride-hailing application). If there is a significant difference between the two corresponding values, the GPS values may be spoofed. Otherwise, the GPS values may not be spoofed.

In some embodiments, the one or more sensing data may further include user specific data. In some embodiments, the user specific data may include at least one of information about whether a predetermined application is installed in the computing device 160, and information about whether a location of a Wi-Fi/cell tower is mapped to the location data.

In some embodiments, the processor 120 may determine a probability that the location data is manipulated based on the score obtained by the machine learning model. In some embodiments, the processor 120 may compare the score and a predetermined threshold. In some embodiments, the processor 120 may obtain one or more scores each associated with the one or more sensing data, aggregate the one or more scores (for example, obtaining an average of the one or more scores) and compare the aggregated score and the predetermined threshold. In some other embodiments, the processor 120 may obtain the one or more scores each associated with the one or more sensing data, compare the one or more scores and one or more predetermined thresholds each associated with the one or more sensing data. In some other embodiments, the processor 120 may obtain the one or more sensing data, obtain a single score based on the one or more sensing data, and compare the single score and the predetermined threshold. In some embodiments, the processor 120 may determine whether the location data is manipulated based on the comparison between the score and the predetermined threshold. In some embodiments, if the score is equal to or greater than the predetermined threshold, the processor 120 may determine that the location data is manipulated. In some embodiments, if the score is less than the predetermined threshold, the processor 120 may determine that the location data is not manipulated.

In some embodiments, the machine learning model may be used to combine the above-mentioned different signals (i.e. the one or more sensing data) into the score (for example, the single score or the aggregated score) to assess whether GPS spoofing is present. In some embodiments, a tree-based model like a random forest may be used as it may allow interactions between features generated from these signals (i.e. the one or more sensing data). In some embodiments, a higher score from this model may indicate a higher likelihood of the GPS spoofing and appropriate thresholds may be set for different actions of varying severity taken against the user 170.

In some embodiments, if it is determined that the location data is manipulated, the processor 120 may trigger the user 170 to perform a predetermined task to allow the user to provide an on-demand service relating to the location data. For example, if it is determined that the location data is manipulated, the processor 120 may request the user 170 to verify that the location data is not manipulated, to provide the on-demand service relating to the location data. As another example, if it is determined that the location data is manipulated, the processor 120 may request the user 170 to take a penalty to continue with a provision of the on-demand service.

In some embodiments, the processor 120 may set a plurality of predetermined thresholds each corresponding to a plurality of scenarios for the on-demand service, based on a critical level of each of the plurality of scenarios. In some embodiments, the processor 120 may determine one of the plurality of scenarios based on characteristics of an order for the on-demand service. In some embodiments, the processor 120 may compare the score and one of the plurality of predetermined thresholds corresponding to the determined scenario, to determine whether the location data is manipulated. For example, the processor 120 may set a certain threshold (hereinafter, referred to as a “first threshold”) corresponding to a scenario of a provision of an incentive to the driver. The processor 120 may determine that the location data is manipulated, if the score for the trace of the location data of the driver is equal to or greater than the first threshold. As another example, the processor 120 may set a certain threshold (hereinafter, referred to as a “second threshold”) corresponding to a scenario of a report of a current location of the driver. The second threshold may be less than the first threshold. The processor 120 may determine that the location data is manipulated, if the score for the location data of the driver is equal to or greater than the second threshold.

FIG. 3 illustrates a flow diagram for a method 300 for facilitating detecting a manipulation of location data according to various embodiments.

According to various embodiments, the method 300 for facilitating detecting the manipulation of the location data may be provided.

In some embodiments, the method 300 may include a step 301 of obtaining the location data from a computing device associated with a user.

In some embodiments, the method 300 may include a step 302 of obtaining one or more sensing data detected by one or more sensors of the computing device from the computing device.

In some embodiments, the method 300 may include a step 303 of inputting the one or more sensing data and the location data into a machine learning model. In some embodiments, the machine learning model is configured to aggregate the one or more sensing data and the location data, and output a score based on a model probability for the manipulation.

In some embodiments, the method 300 may include a step 304 of determining a probability that the location data is manipulated based on the score.

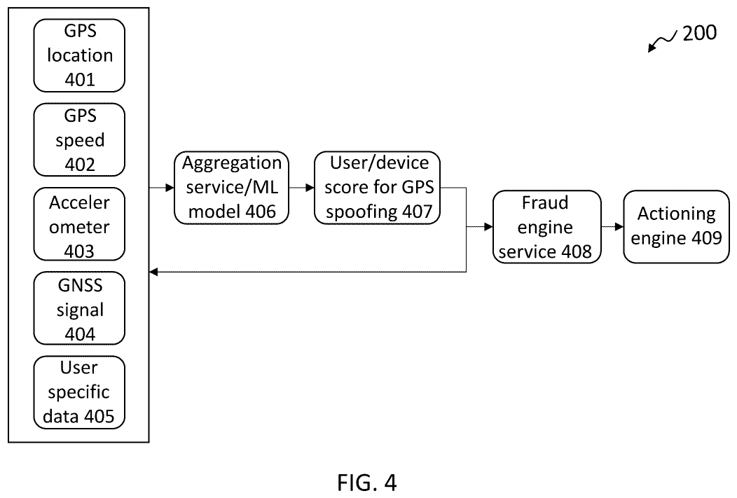

FIG. 4 illustrates a data flow diagram for a system 200 for facilitating detecting a manipulation of location data according to various embodiments.

In some embodiments, as a first step of detecting the manipulation of the location data of a computing device 160, a processor 120 of a server 100 may obtain one or more sensing data including, but not limited to, at least one of raw GPS (Global Positioning System) measurements data, accelerometer data, and raw GNSS (Global Navigation Satellite System) measurements data from the computing device 160 for a time window of interest. In some embodiments, the one or more sensing data may further include user specific data. For example, the user specific data may include, but is not limited to, at least one of information about whether a predetermined application (for example, suspicious apps) is installed in the computing device 160, and information about whether a location of a Wi-Fi/cell tower is mapped to the location data. In some embodiments, the user specific data may supplement the detection of the manipulation of the location data.

In some embodiments, where the one or more sensing data includes the raw GPS measurements data relating to GPS location (401), the processor 120 may obtain GPS longitude data and GPS latitude data from the computing device 160 associated with a user 170 (for example, a driver). The processor 120 may compute a relative distance of the GPS longitude data and the GPS latitude data of the computing device 160 associated with the user 170 to a pick-up location and a drop-off location. The processor 120 may compute a distribution of the location data of the computing device 160 associated with the user 170, to determine a normal user behaviour (for example, based on a score obtained by the relative distance and the distribution).

In some embodiments, where the one or more sensing data includes the raw GPS measurements data relating to GPS speed (402), the processor 120 may obtain GPS speed data and GPS accuracy data of the computing device 160 associated with the user 170. The processor 120 may exclude poor quality GPS pings based on the GPS accuracy data from a GPS sensor. For example, the processor 120 may exclude at least one GPS ping which is less than a predetermined quality value, based on the GPS accuracy data. The processor 120 may compute a variance of the GPS speed data, to obtain the score based on at least one remaining GPS ping and the variance.

In some embodiments, where the one or more sensing data includes the accelerometer data (403), the processor 120 may obtain 3-axis accelerometer data of the computing device 160. The processor 120 may obtain a vibrational pattern of the computing device 160 in a frequency domain by inputting the 3-axis accelerometer data into an FFT (Fast Fourier Transform) algorithm. The processor 120 may determine whether the computing device 160 is in a vehicle based on the vibrational pattern, to obtain the score based on whether the computing device is in the vehicle.

In some embodiments, where the one or more sensing data includes the raw GNSS measurements data (404), the processor 120 may obtain the raw GNSS measurements data from a GNSS module. The processor 120 may perform a calculation from the raw GNSS measurements data, to obtain GNSS latitude data and GNSS longitude data of the computing device 160. The GNSS location values (for example, the GNSS latitude data and the GNSS longitude data) are compared with the location data (for example, GPS data) directly read from the GPS sensor, by third party applications. The processor 120 may obtain the score based on the comparison between the GNSS location values and the location data. For example, if a difference between the GNSS location values and the location data is significantly different, the processor 120 may determine that GPS spoofing is likely present. The processor 120 may set a threshold value for the difference to detect possible FGPS usage. As an example, the data analysed may be over a sufficiently long duration to exclude transient spikes due to GPS drifts.

In some embodiments, where the one or more sensing data includes the user specific data (405), the processor 120 may check if there are one or more suspicious applications that are known to enable GPS spoofing in the computing device 160. For example, if a predetermined suspicious application is installed in the computing device 160, the processor 120 may determine that GPS spoofing is likely present. In some embodiments, the processor 120 may check whether the location of the Wi-Fi/cell tower is mapped to the location data (GPS location data). For example, if the Wi-Fi/cell tower location mapping is not consistent with the location data, the processor 120 may determine that GPS spoofing is likely present.

In some embodiments, as a second step of detecting the manipulation of the location data of a computing device 160, the processor 120 may combine the obtained one or more sensing data (406) and input the combined data to a machine learning model which may output one or more scores (also referred to as “FGPS scores”) based on multiple probabilities of the machine learning model for the FGPS usage (407). In some embodiments, the machine learning model may return probabilities from 0 to 1 which indicates the machine learning model's confidence level if given data is GPS spoofing. Since the processor 120 may use the sensing data from different sensors, there may be multiple probabilities each indicating the FGPS confidence based on respective data source.

In some embodiments, as a third step of detecting the manipulation of the location data of a computing device 160, the processor 120 may include a fraud engine service (408). In some embodiments, the fraud engine service may evaluate a probability of a fraudulent booking (also referred to as an “order”). The fraud engine service may achieve this by gathering fundamental metadata and derived metadata during the post-booking stage. The fundamental metadata may encompass the accelerometer data and alterations of the GPS latitude data and the GPS longitude data. The derived metadata may incorporate the FGPS scores. The fraud engine service may label every entity in this booking, including a consumer (for example, a passenger), a driver, and the booking.

In some embodiments, as a fourth step of detecting the manipulation of the location data of a computing device 160, the processor 120 may include an actioning engine (also referred to as an “action platform”) (409). In some embodiments, the actioning engine may execute appropriate actions based on the booking verdict and specific scenarios. For example, if the driver is suspected of using a fake GPS application, the actioning engine may withhold the driver's pay-out for the current booking and prevent the driver from being assigned further bookings until the driver contacts a customer service for a verification.

As described above, on the on-demand service platform, the drivers may play a crucial role. Like with many digital platforms, the transition to online cashless transactions may introduce significant fraud risks. Specifically, the on-demand service platform may have vulnerability to fraudulent activities such as GPS spoofing, where the drivers manipulate location data to unfairly benefit from system allocations, and generate fictitious rides for financial incentives, among other deceptive practices. To address the challenge of GPS spoofing, the various embodiments introduce leveraging sophisticated device signal data encompassing telematics and the GNSS measurements data, integrated with a fraud detection system specifically designed to combat such fraudulent activities efficiently. It may be appreciated that the various embodiments may be used in any ride or transportation service platform for ensuring a genuine transportation service provided by the drivers. In addition, it may be appreciated that the various embodiments may be used by gaming companies that provide games that rely on user's GPS data as a game input.

As described above, the various embodiments provide a one-size-fits-all solution to the GPS spoofing problem by utilising a myriad of measurements that may be obtained from the computing device 160 of the user 170. A conventional spoofing application may be able to easily change output GPS values by a third-party application as there may be only a few numerical values of interest (for example, latitude and longitude). However, it is much less straightforward to modify raw accelerometer data or GNSS measurements data to return the desired values that matches the required GPS output. In addition, a vibrational motion generated by a moving vehicle is hard to mimic. Moreover, the raw GNSS measurements data may include raw pseudo-range and carrier phase information from satellites spanning a plurality of data fields, for example, 36 data fields. Each of these data fields may need to be edited accordingly such that they return the desired values after the computation. Current solutions based on the suspicious GPS trace or computing device data may have some degree of uncertainty when they are used on their own and work better when they are used together in tandem in a machine learning model. Even if GPS spoofing evolves to evade some of these signals, they may be detected as long as others are able to flag it.

In the following, various examples of this disclosure are illustrated:
Example 1 is a server for facilitating detecting a manipulation of location data, the server comprising: a memory configured to store instructions; and a processor for executing the stored instructions and configured to: obtain the location data from a computing device associated with a user; obtain one or more sensing data detected by one or more sensors of the computing device from the computing device; input the one or more sensing data and the location data into a machine learning model, wherein the machine learning model is configured to aggregate the one or more sensing data and the location data, and output a score based on a model probability for the manipulation; and determine a probability that the location data is manipulated based on the score.
Example 2 is the server according to Example 1, wherein the processor is further configured to: compare the score and a predetermined threshold; and determine whether the location data is manipulated based on the comparison between the score and the predetermined threshold, wherein if the score is equal to or greater than the predetermined threshold, the processor is configured to determine that the location data is manipulated; and if the score is less than the predetermined threshold, the processor is configured to determine that the location data is not manipulated.
Example 3 is the server according to Example 2, wherein the processor is further configured to: if it is determined that the location data is manipulated, trigger the user to perform a predetermined task to allow the user to provide an on-demand service relating to the location data.
Example 4 is the server according to Example 2 or Example 3, wherein the processor is further configured to: set a plurality of predetermined thresholds each corresponding to a plurality of scenarios for the on-demand service, based on a critical level of each of the plurality of scenarios; determine one of the plurality of scenarios based on characteristics of an order for the on-demand service; and compare the score and one of the plurality of predetermined thresholds corresponding to the determined scenario, to determine whether the location data is manipulated.
Example 5 is the server according to any one of Examples 1 to 4, wherein the one or more sensing data include at least one of raw GPS (Global Positioning System) measurements data, accelerometer data, and raw GNSS (Global Navigation Satellite System) measurements data.
Example 6 is the server according to Example 5, wherein the raw GPS measurements data includes GPS longitude data and GPS latitude data of the computing device, and the machine learning model is further configured to compute a relative distance of the GPS longitude data and the GPS latitude data to a pick-up location and a drop-off location, and compute a distribution of the location data, to obtain the score based on the relative distance and the distribution.
Example 7 is the server according to Example 5 or Example 6, wherein the raw GPS measurements data includes GPS speed data and GPS accuracy data of the computing device, and the machine learning model is further configured to exclude at least one GPS ping which is less than a predetermined quality value, based on the GPS accuracy data, and compute a variance of the GPS speed data, to obtain the score based on at least one remaining GPS ping and the variance.
Example 8 is the server according to any one of Examples 5 to 7, wherein the accelerometer data includes 3-axis accelerometer data of the computing device, and the machine learning model is further configured to obtain a vibrational pattern of the computing device in a frequency domain by inputting the 3-axis accelerometer data into an FFT (Fast Fourier Transform) algorithm, and determine whether the computing device is in a vehicle based on the vibrational pattern, to obtain the score based on whether the computing device is in the vehicle.
Example 9 is the server according to any one of Examples 5 to 8, wherein the machine learning model is further configured to perform a calculation using the raw GNSS measurements data to obtain GNSS latitude data and GNSS longitude data of the computing device; and compare the GNSS latitude data and the GNSS longitude data with the location data, to obtain the score based on the comparison between the GNSS latitude data and the GNSS longitude data and the location data.
Example 10 is the server according to any one of Examples 5 to 9, wherein the one or more sensing data further include user specific data, and the user specific data includes at least one of information about whether a predetermined application is installed in the computing device, and information about whether a location of a cell tower is mapped to the location data.
Example 11 is a method for facilitating detecting a manipulation of location data, the method comprising: obtaining the location data from a computing device associated with a user; obtaining one or more sensing data detected by one or more sensors of the computing device from the computing device; inputting the one or more sensing data and the location data into a machine learning model, wherein the machine learning model is configured to aggregate the one or more sensing data and the location data, and output a score based on a model probability for the manipulation; and determining a probability that the location data is manipulated based on the score.
Example 12 is the method according to Example 11, wherein the determining the probability that the location data is manipulated based on the score comprising: comparing the score and a predetermined threshold; and determining whether the location data is manipulated based on the comparison between the score and the predetermined threshold, wherein the determining whether the location data is manipulated based on the comparison between the score and the predetermined threshold comprising: if the score is equal to or greater than the predetermined threshold, determining that the location data is manipulated; and if the score is less than the predetermined threshold, determining that the location data is not manipulated.
Example 13 is the method according to Example 12, further comprising: if it is determined that the location data is manipulated, triggering the user to perform a predetermined task to allow the user to provide an on-demand service relating to the location data.
Example 14 is the method according to Example 12 or Example 13, wherein the determining the probability that the location data is manipulated based on the score comprising: setting a plurality of predetermined thresholds each corresponding to a plurality of scenarios for the on-demand service, based on a critical level of each of the plurality of scenarios; determining one of the plurality of scenarios based on characteristics of an order for the on-demand service; and comparing the score and one of the plurality of predetermined thresholds corresponding to the determined scenario, to determine whether the location data is manipulated.
Example 15 is the method according to any one of Examples 11 to 14, wherein the one or more sensing data include at least one of raw GPS (Global Positioning System) measurements data, accelerometer data, and raw GNSS (Global Navigation Satellite System) measurements data.
Example 16 is the method according to Example 15, wherein the raw GPS measurements data includes GPS longitude data and GPS latitude data of the computing device, and the machine learning model is further configured to compute a relative distance of the GPS longitude data and the GPS latitude data to a pick-up location and a drop-off location, and compute a distribution of the location data, to obtain the score based on the relative distance and the distribution.
Example 17 is the method according to Example 15 or Example 16, wherein the raw GPS measurements data includes GPS speed data and GPS accuracy data of the computing device, and the machine learning model is further configured to exclude at least one GPS ping which is less than a predetermined quality value, based on the GPS accuracy data, and compute a variance of the GPS speed data, to obtain the score based on at least one remaining GPS ping and the variance.
Example 18 is the method according to any one of Examples 15 to 17, wherein the accelerometer data includes 3-axis accelerometer data of the computing device, and the machine learning model is further configured to obtain a vibrational pattern of the computing device in a frequency domain by inputting the 3-axis accelerometer data into an FFT (Fast Fourier Transform) algorithm, and determine whether the computing device is in a vehicle based on the vibrational pattern, to obtain the score based on whether the computing device is in the vehicle.
Example 19 is the method according to any one of Examples 15 to 18, wherein the machine learning model is further configured to perform a calculation using the raw GNSS measurements data to obtain GNSS latitude data and GNSS longitude data of the computing device; and compare the GNSS latitude data and the GNSS longitude data with the location data, to obtain the score based on the comparison between the GNSS latitude data and the GNSS longitude data and the location data.
Example 20 is the method according to any one of Examples 15 to 19, wherein the one or more sensing data further include user specific data, and the user specific data includes at least one of information about whether a predetermined application is installed in the computing device, and information about whether a location of a cell tower is mapped to the location data.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A server for facilitating detecting a manipulation of location data, the server comprising:
a memory configured to store instructions; and
a processor for executing the stored instructions and configured to:
obtain the location data from a computing device associated with a user;
obtain one or more sensing data detected by one or more sensors of the computing device from the computing device;
input the one or more sensing data and the location data into a machine learning model, wherein the machine learning model is configured to aggregate the one or more sensing data and the location data, and output a score based on a model probability for the manipulation; and
determine a probability that the location data is manipulated based on the score.

2. The server according to claim 1, wherein the processor is further configured to:
compare the score and a predetermined threshold; and
determine whether the location data is manipulated based on the comparison between the score and the predetermined threshold,
wherein if the score is equal to or greater than the predetermined threshold, the processor is configured to determine that the location data is manipulated; and
if the score is less than the predetermined threshold, the processor is configured to determine that the location data is not manipulated.

3. The server according to claim 2, wherein the processor is further configured to:
if it is determined that the location data is manipulated, trigger the user to perform a predetermined task to allow the user to provide an on-demand service relating to the location data.

4. The server according to claim 3, wherein the processor is further configured to:
set a plurality of predetermined thresholds each corresponding to a plurality of scenarios for the on-demand service, based on a critical level of each of the plurality of scenarios;
determine one of the plurality of scenarios based on characteristics of an order for the on-demand service; and
compare the score and one of the plurality of predetermined thresholds corresponding to the determined scenario, to determine whether the location data is manipulated.

5. The server according to claim 1, wherein the one or more sensing data include at least one of raw GPS (Global Positioning System) measurements data, accelerometer data, and raw GNSS (Global Navigation Satellite System) measurements data.

6. The server according to claim 5, wherein the raw GPS measurements data includes GPS longitude data and GPS latitude data of the computing device, and
the machine learning model is further configured to compute a relative distance of the GPS longitude data and the GPS latitude data to a pick-up location and a drop-off location, and compute a distribution of the location data, to obtain the score based on the relative distance and the distribution.

7. The server according to claim 5, wherein the raw GPS measurements data includes GPS speed data and GPS accuracy data of the computing device, and
the machine learning model is further configured to exclude at least one GPS ping which is less than a predetermined quality value, based on the GPS accuracy data, and compute a variance of the GPS speed data, to obtain the score based on at least one remaining GPS ping and the variance.

8. The server according to claim 5, wherein the accelerometer data includes 3-axis accelerometer data of the computing device, and
the machine learning model is further configured to obtain a vibrational pattern of the computing device in a frequency domain by inputting the 3-axis accelerometer data into an FFT (Fast Fourier Transform) algorithm, and determine whether the computing device is in a vehicle based on the vibrational pattern, to obtain the score based on whether the computing device is in the vehicle.

9. The server according to claim 5, wherein the machine learning model is further configured to perform a calculation using the raw GNSS measurements data to obtain GNSS latitude data and GNSS longitude data of the computing device; and
compare the GNSS latitude data and the GNSS longitude data with the location data, to obtain the score based on the comparison between the GNSS latitude data and the GNSS longitude data and the location data.

10. The server according to claim 5, wherein the one or more sensing data further include user specific data, and
the user specific data includes at least one of information about whether a predetermined application is installed in the computing device, and information about whether a location of a cell tower is mapped to the location data.

11. A method for facilitating detecting a manipulation of location data, the method comprising:
obtaining the location data from a computing device associated with a user;
obtaining one or more sensing data detected by one or more sensors of the computing device from the computing device;
inputting the one or more sensing data and the location data into a machine learning model, wherein the machine learning model is configured to aggregate the one or more sensing data and the location data, and output a score based on a model probability for the manipulation; and
determining a probability that the location data is manipulated based on the score.

12. The method according to claim 11, wherein the determining the probability that the location data is manipulated based on the score comprising:
comparing the score and a predetermined threshold; and
determining whether the location data is manipulated based on the comparison between the score and the predetermined threshold,
wherein the determining whether the location data is manipulated based on the comparison between the score and the predetermined threshold comprising:
if the score is equal to or greater than the predetermined threshold, determining that the location data is manipulated; and
if the score is less than the predetermined threshold, determining that the location data is not manipulated.

13. The method according to claim 12, further comprising:
if it is determined that the location data is manipulated, triggering the user to perform a predetermined task to allow the user to provide an on-demand service relating to the location data.

14. The method according to claim 13, wherein the determining the probability that the location data is manipulated based on the score comprising:
setting a plurality of predetermined thresholds each corresponding to a plurality of scenarios for the on-demand service, based on a critical level of each of the plurality of scenarios;
determining one of the plurality of scenarios based on characteristics of an order for the on-demand service; and
comparing the score and one of the plurality of predetermined thresholds corresponding to the determined scenario, to determine whether the location data is manipulated.

15. The method according to claim 11, wherein the one or more sensing data include at least one of raw GPS (Global Positioning System) measurements data, accelerometer data, and raw GNSS (Global Navigation Satellite System) measurements data.

16. The method according to claim 15, wherein the raw GPS measurements data includes GPS longitude data and GPS latitude data of the computing device, and
the machine learning model is further configured to compute a relative distance of the GPS longitude data and the GPS latitude data to a pick-up location and a drop-off location, and compute a distribution of the location data, to obtain the score based on the relative distance and the distribution.

17. The method according to claim 15, wherein the raw GPS measurements data includes GPS speed data and GPS accuracy data of the computing device, and
the machine learning model is further configured to exclude at least one GPS ping which is less than a predetermined quality value, based on the GPS accuracy data, and compute a variance of the GPS speed data, to obtain the score based on at least one remaining GPS ping and the variance.

18. The method according to claim 15, wherein the accelerometer data includes 3-axis accelerometer data of the computing device, and
the machine learning model is further configured to obtain a vibrational pattern of the computing device in a frequency domain by inputting the 3-axis accelerometer data into an FFT (Fast Fourier Transform) algorithm, and determine whether the computing device is in a vehicle based on the vibrational pattern, to obtain the score based on whether the computing device is in the vehicle.

19. The method according to claim 15, wherein the machine learning model is further configured to perform a calculation using the raw GNSS measurements data to obtain GNSS latitude data and GNSS longitude data of the computing device; and
compare the GNSS latitude data and the GNSS longitude data with the location data, to obtain the score based on the comparison between the GNSS latitude data and the GNSS longitude data and the location data.

20. The method according to claim 15, wherein the one or more sensing data further include user specific data, and
the user specific data includes at least one of information about whether a predetermined application is installed in the computing device, and information about whether a location of a cell tower is mapped to the location data.
